(19) United States
(12) Patent Application Publication
(10) Pub. No.: US 2026/0331402 A1
(43) Pub. Date: Oct. 22, 2026

(54) SWITCH DEVICE

(71) Applicant: ALPS ALPINE CO., LTD., Tokyo (JP)

(72) Inventor: Kazuyoshi YAMAGATA, Fukushima (JP)

(21) Appl. No.: 19/644,521

(22) Filed: Apr. 10, 2026

(30) Foreign Application Priority Data
Apr. 22, 2025 (JP) 2025-070398

(51) Int. Cl. H01H 25/00; H01H 3/46; H01H 23/14; H01H 23/16

(52) U.S. Cl. CPC H01H 25/006; H01H 3/46; H01H 23/143; H01H 23/168; H01H 2231/026

(57) ABSTRACT

A switch device includes an actuator, a first cam, a second cam, a plurality of plungers, a plurality of movable contacts, and a plurality of fixed contacts. The first cam is engaged with an elongated hole formed in the actuator and extending in the front-rear direction of the actuator, and is configured to rotate upon pressing-down or pulling-up of the front or rear end portion of the actuator. The second cam is engaged with the actuator and configured to rotate upon a movement of the actuator in the front-rear direction. The plungers are configured to be individually pressed down in response to rotation of the first or second cam. Each of the movable contacts is configured to be pressed down by a corresponding one of the plungers. Each of the fixed contacts is provided opposed to a corresponding one of the movable contacts.

### CROSS-REFERENCE TO RELATED APPLICATIONS

This application claims priority to Japanese Patent Application No. 2025-070398, filed Apr.22, 2025, the entire content of which is incorporated herein by reference.

### BACKGROUND

### 1. Technical Field

The present invention relates to a switch device.

### 2. Description of Related Art

Japanese Unexamined Patent Application Publication No. H6-290685 (hereinafter "Patent Document 1") discloses a four-stage switching rocker switch device.

### SUMMARY

One aspect of the present invention provides a switch device including: an actuator, a first cam configured to rotate when a front end portion or a rear end portion of the actuator is pressed down or pulled up, the first cam being engaged with an elongated hole extending in a front-rear direction of the actuator and formed in the actuator, a second cam engaged with the actuator and configured to rotate due to movement of the actuator in the front-rear direction, a plurality of plungers configured to be individually pressed down in response to rotation of the first cam or the second cam, a plurality of movable contacts, each movable contact being configured to be pressed down by a corresponding one of the plurality of plungers, and a plurality of fixed contacts, each fixed contact being provided opposed to a corresponding one of the plurality of movable contacts.

### BRIEF DESCRIPTION OF THE DRAWINGS

FIG. 1 is a perspective view of a switch device according to an embodiment of the present invention;

FIG. 2 is a perspective view of the switch device of FIG. 1, with some components removed for clarity;

FIG. 3 is an exploded perspective view of the switch device of FIG. 2;

FIG. 4 is a perspective view of the switch device of FIG. 2, with some components assembled;

FIG. 5 is a side view illustrating a state of the switch device of FIG. 2 when an actuator is not operated;

FIG. 6 is a side view illustrating a state of the switch device of FIG. 2 when the actuator is pressed down;

FIG. 7 is a side view illustrating a state of the switch device of FIG. 2 when the actuator is pulled up; and

FIG. 8 is a side view illustrating a state of the switch device of FIG. 2 when the actuator undergoes a translational motion.

### DETAILED DESCRIPTION

Like a conventional rocker switch, a switch device in which an actuator is operated by rocking cannot accept translational operation of the actuator. Conversely, a switch device in which an actuator is operated by translational movement cannot accept rocking operation. Therefore, it has been necessary to separately provide a switch device configured for rocking operation and a switch device configured for translational operation.

According to the above aspect, it is possible to provide a switch device configured for both rocking operation and translational operation.

Hereinafter, an embodiment of the invention will be described with reference to the drawings. In order to facilitate understanding of the description, the same reference numerals are given to the same components in each of the drawings, and duplicate description is omitted. In each drawing, the scale of each part may differ from the actual scale.

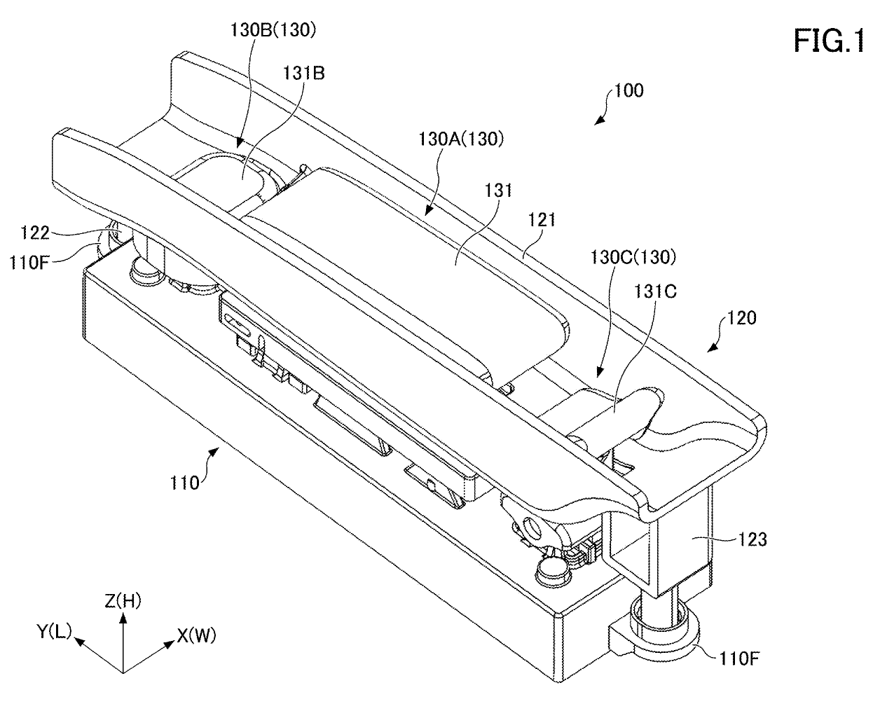

FIG. 1 is a perspective view of a switch device 100 according to an embodiment of the present invention. The switch device 100 according to the present embodiment is installed in a portion of a relatively limited space in a cabin of an automobile, such as a vehicle seat, an instrument panel, or a door trim, and can be used to adjust the seat height, front-back position, backrest recline angle, or the like. The switch device 100 is not restricted to installation in a vehicle and may be applied to the operation of various types of devices.

Each drawing illustrates a three-dimensional rectangular coordinate system having an X-axis parallel to the width direction W of the switch device 100, a Y-axis parallel to the longitudinal direction L of the switch device 100, and a Z-axis parallel to the height direction H of the switch device 100. In the present embodiment, for example, one direction (the positive direction of the Y-axis) in the longitudinal direction L of the switch device 100 is defined as the front direction, and the opposite direction (the negative direction of the Y-axis) is defined as the rear direction. In other words, in the present embodiment, the front-rear direction of the switch device 100 is the longitudinal direction L (the Y-axis direction) of the switch device 100. In the following description, the width direction W, the longitudinal direction L, and the height direction H of the switch device 100 are simply referred to as the width direction W, the longitudinal direction L, and the height direction H.

The switch device 100 includes, for example, a case 110, an exterior frame 120, and actuators 130. The case 110 is, for example, a rectangular parallelepiped housing, and has flange portions 110F at respective ends in the longitudinal direction L, namely the front and rear ends of the case 110. The case 110 rotatably and linearly supports, for example, cams and plungers, which will be described later, and accommodates other components of the switch device 100, such as an elastic sheet provided with movable contacts and a printed wiring board provided with fixed contacts.

The exterior frame 120 includes, for example, a frame body 121 and support leg portions 122 and 123 for respectively supporting the front and rear ends of the frame body 121 from below. The frame body 121 is, for example, a recessed groove-like or channel-shaped member extending in the front-rear direction. The bottom portion of the frame body 121 is provided with openings at positions corresponding to the respective actuators 130.

The lower end of the support leg portion 122 for supporting the front end of the frame body 121 is supported from below by the flange portion 110F provided at the front end of the case 110 and is fixed to the flange portion 110F by a bolt from below. The lower end of the support leg portion 123 for supporting the rear end of the frame body 121 is supported from below by the flange portion 110F provided at the rear end of the case 110, and is fixed to the flange portion 110F by a bolt from below.

In the example illustrated in FIG. 1, the switch device 100 includes three actuators 130. The number of actuators 130 included in the switch device 100 is not particularly limited, and may be one, two, or three or more. Of the three actuators 130 illustrated in FIG. 1, a central actuator 130A can accept translational operation of the operation knob 131 in the front-rear direction, in addition to rocking operation of the operation knob 131 caused by pressing down or pulling up the front end or the rear end of the operation knob 131.

On the other hand, an actuator 130B arranged at a forward-most position among the three actuators 130 illustrated in FIG. 1 allows only a one-way operation in which the operation knob 131B is pressed down in the height direction H (in the negative direction of the Z axis). An actuator 130C arranged at a rearward-most position among the three actuators 130 illustrated in FIG. 1 allows only a rocking operation in which the operation knob 131C is tilted back and forth. The configurations of the actuators 130B and 130C are the same as those of known actuators, and therefore, description of the actuators 130B and 130C is omitted.

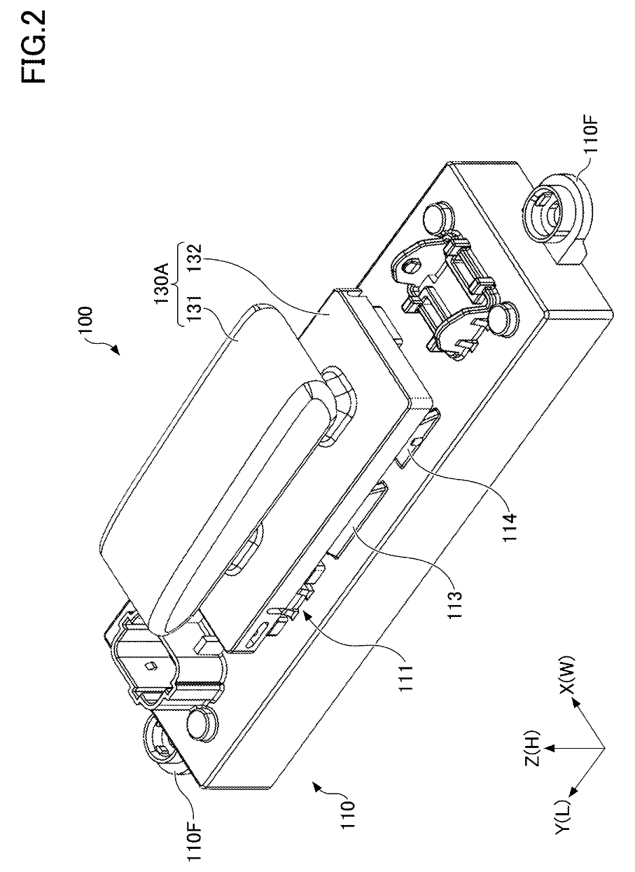

Hereinafter, the configuration of the switch device 100, including the actuator 130A configured to allow both a rocking operation and a translational operation of the operation knob 131, will be described in detail with reference to FIGS. 2 through 8.

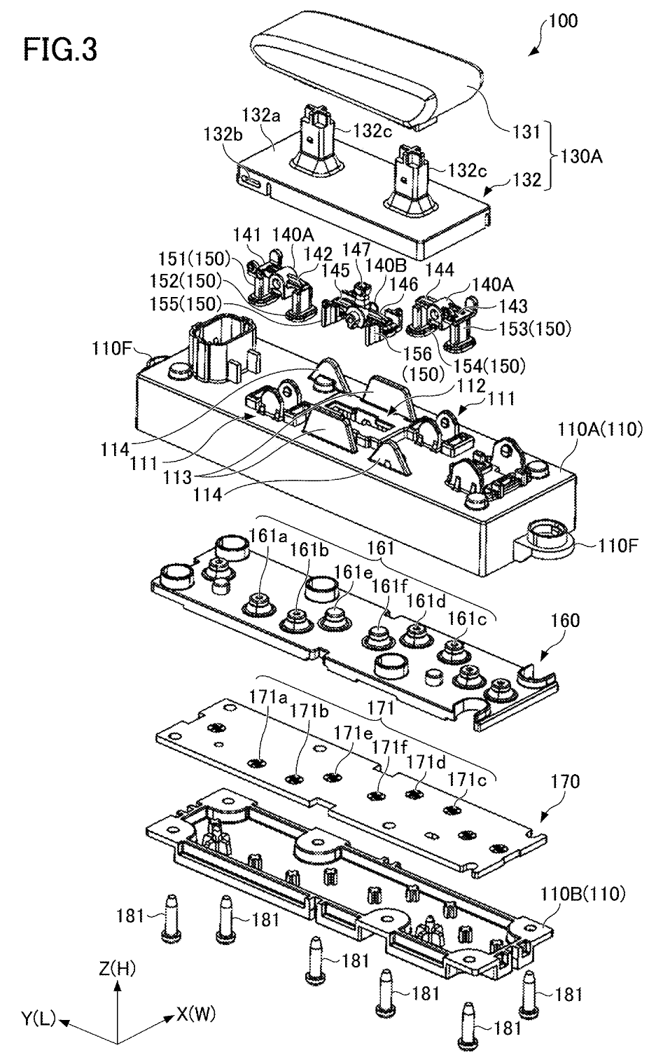

FIG. 2 is a perspective view of the switch device 100 from which the exterior frame 120, the actuators 130B and 130C located at the respective front and rear portions of the exterior frame 120, and other components such as cams and plungers corresponding to the exterior frame 120 and the actuators 130B and 130C have been removed from the switch device 100 illustrated in FIG. 1 for clarity. FIG. 3 is an exploded perspective view of the switch device 100 illustrated in FIG. 2.

The switch device 100 mainly includes the actuator 130A, a first cam 140A, a second cam 140B, a plurality of plungers 150, a plurality of movable contacts 161, and a plurality of fixed contacts 171. Specifically, the switch device 100 further includes, for example, an elastic sheet 160 provided with the plurality of movable contacts 161. The switch device 100 also includes, for example, a printed wiring board 170 provided with the plurality of fixed contacts 171.

The switch device 100 may further include the case 110 described above. The case 110 rotatably supports, for example, the first cam 140A and the second cam 140B. The case 110 also vertically movably supports, for example, the plurality of plungers 150. The case 110 includes, for example, an upper case 110A and a lower case 110B, as illustrated in FIG. 3.

The upper case 110A has, for example, a shape of a rectangular parallelepiped box with an open bottom, and the flange portions 110F are located on the front side and the rear side of the upper case 110A, respectively. The upper surface of the upper case 110A is provided with, for example, a first cam support 111 for rotatably supporting the first cam 140A and a second cam support 112 for rotatably supporting the second cam 140B. The upper surface of the upper case 110A is further provided with, for example, rocking support portions 113 for supporting the actuator 130A in a rockable manner and rocking regulating portions 114 for regulating rocking of the actuator 130A.

More specifically, the upper case 110A has one second cam support 112, which is arranged at the center of the upper surface, and two first cam supports 111, which are respectively arranged in front of and behind the second cam support 112 in the front-rear direction. Of the two first cam support portions 111, one on the front side is arranged on the left side of the center in the width direction W (negative direction side of the X-axis direction) when the case 110 is viewed from the rear side to the front side in the longitudinal direction L (from the negative direction side to the positive direction side of the Y-axis direction). The other on the rear side is arranged on the right side of the center in the width direction W (the positive direction side of the X-axis direction) when the case 110 is viewed from the rear side to the front side in the longitudinal direction L.

The lower case 110B is a rectangular plate-like member for closing the open bottom of the upper case 110A. The lower case 110B has, for example, a plurality of through-holes through which bolts 181 are inserted, and is attached to the upper case 110A by screwing the bolts 181 inserted into the respective through-holes into the screw holes of the upper case 110A. The upper surface of the lower case 110B is provided with, for example, a plurality of columnar portions for respectively supporting the fixed contacts 171 provided on the printed wiring board 170 from below.

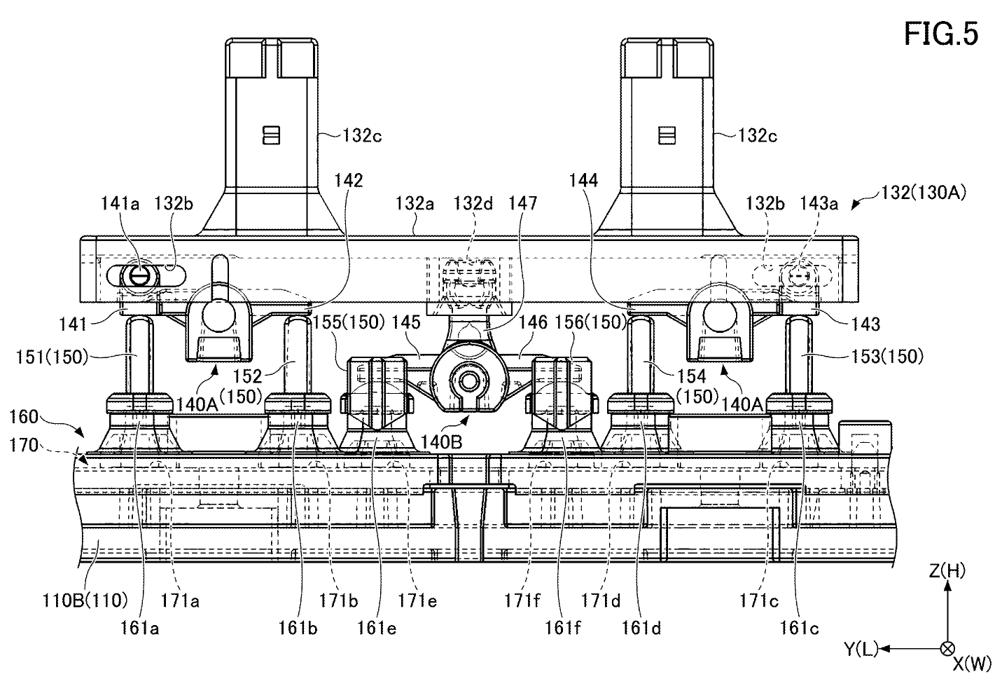

The actuator 130A includes, for example, the operation knob 131, a base portion 132 connected to the lower portion of the operation knob 131, and a recess 132d (see FIG. 5) provided in the lower surface of the base portion 132 for receiving the second cam 140B. The recess 132d in the lower surface of the base portion 132 will be described later with reference to FIG. 5. The operation knob 131 has, for example, a shape imitating the shape of a seat cushion. Specifically, the operation knob 131 has, for example, a dimension in the longitudinal direction L larger than that in the width direction W, and a dimension in the height direction H smaller than that in the width direction W. The operation knob 131 has a three-dimensional shape having a front end and a rear end rounded and elongated in the front-rear direction. The shape of the operation knob 131 is not particularly limited as long as the shape is suitable for the hand of a person who operates the switch device 100.

The base portion 132 includes, for example, a tilt slider 132a having a shape of a rectangular plate, elongated holes 132b formed in respective side surfaces of the tilt slider 132a, and connecting portions 132c provided on the upper surface of the tilt slider 132a.

The tilt slider 132a is arranged in the lower portion of the actuator 130A. The elongated holes 132b extend in the front-rear direction of the actuator 130A, which corresponds to the longitudinal direction L. Specifically, the elongated holes 132b are formed in, for example, the respective front and rear end portions of the actuator 130A. More specifically, one elongated hole 132b is located at one side in the width direction W at the front end portion of the tilt slider 132a, and the other elongated hole 132b is located at the opposite side in the width direction W at the rear end portion of the tilt slider 132a. The elongated holes 132b are not necessarily formed in the respective front and rear end portions of the actuator 130A, and may be formed in an intermediate portion of the actuator 130A.

The connecting portions 132c are columnar portions extending upward from the upper surface of the tilt slider 132a. The connecting portions 132c are arranged at the respective front and rear portions of the tilt slider 132a so as to be spaced apart from each other in the front-rear direction, which corresponds to the longitudinal direction L. The upper ends of the connecting portions 132c are inserted into and received in respective recesses formed in the lower portion of the operation knob 131, and the operation knob 131 and the base portion 132 are thereby connected via the connecting portions 132c.

By connecting the operation knob 131 and the base portion 132 via the connecting portions 132c, the tilt slider 132a arranged in the lower portion of the actuator 130A is tilted forward and backward with respect to the case 110 by an operation of pressing down or pulling up the front end or the rear end of the operation knob 131. The tilt slider 132a is translated with respect to the case 110 by a translational operation of the operation knob 131 in the front-rear direction.

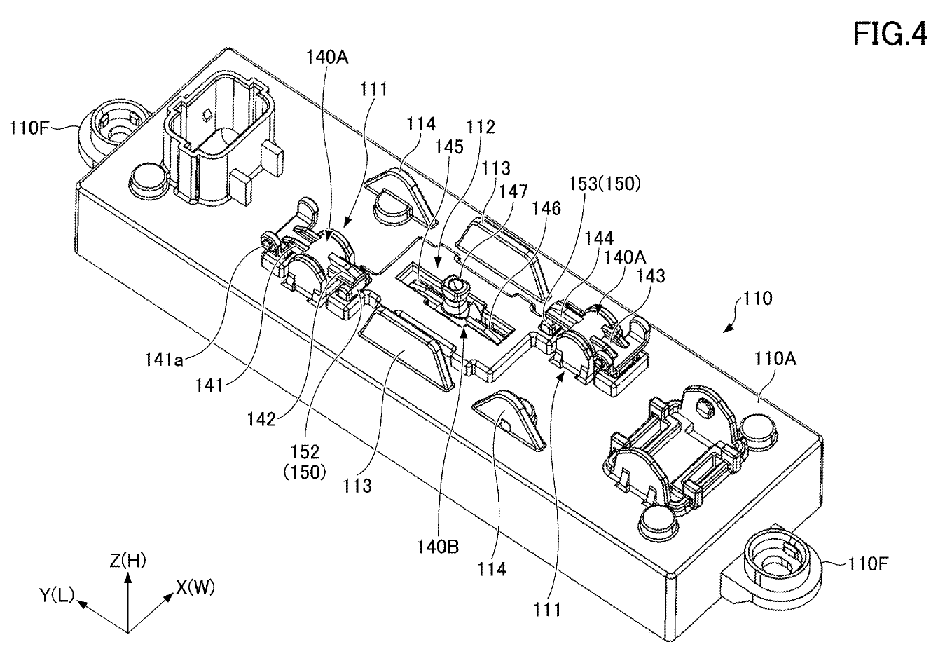

FIG. 4 is a perspective view of the switch device 100 illustrated in FIG. 2, with some components assembled. More specifically, FIG. 4 is a perspective view illustrating a state where the first cams 140A, the second cam 140B, and the plurality of plungers 150 are attached to the upper case 110A of the case 110 illustrated in FIG. 3.

FIG. 5 is a side view illustrating a state where the actuator 130A of the switch device 100 illustrated in FIG. 2 is not being operated. More specifically, FIG. 5 is an enlarged side view of the switch device 100 illustrated in FIG. 2, with the upper case 110A of the case 110 and the operation knob 131 of the actuator 130A omitted. In other words, in FIG. 5, the first cams 140A and the second cam 140B are rotatably supported by the first cam supports 111 and the second cam support 112 of the upper case 110A (not illustrated), and the plungers 150 are also supported by the upper case 110A so as to be movable up and down.

As illustrated in FIG. 4, the case 110 rotatably supports the first cams 140A by the first cam supports 111 of the upper case 110A, for example. Specifically, as illustrated in FIG. 5, each of the first cams 140A has a cylindrical recess formed in its central portion. The recess of the first cam 140A is provided, for example, on each side of the first cam 140A in the width direction W. As illustrated in FIG. 4, the first cam support 111 has a pair of support walls located on respective sides of the first cam 140A in the width direction W, and a pair of cylindrical shaft portions projecting in the width direction W from the respective inner surfaces of the pair of support walls.

The first cam 140A is inserted, for example, between the pair of support walls of the first cam support 111 from above the upper case 110A, and the pair of cylindrical shaft portions of the first cam support 111 are received in the circular recesses formed in the respective sides of the central portion of the first cam 140A. Thus, the case 110 rotatably supports the first cams 140A by the first cam supports 111 of the upper case 110A about a rotation axis parallel to the width direction W orthogonal to the longitudinal direction L (front-rear direction) and the height direction H of the switch device 100. The configuration in which the first cams 140A are rotatably supported by the case 110 is not limited to the configuration illustrated in the drawing, and any configuration may be adopted.

One first cam 140A is supported, for example, by one first cam support 111 provided in the front portion with respect to the center in the longitudinal direction L, and the other first cam 140A is supported by the other first cam support 111 provided in the rear portion with respect to the center in the longitudinal direction L. Thus, as illustrated in FIG. 5, the first cams 140A are arranged at positions corresponding to the respective front and end portions of the actuator 130A in the front-rear direction, which corresponds to the longitudinal direction L.

As illustrated in FIG. 5, the first cam 140A disposed below the front portion of the actuator 130A has a first arm 141 and a second arm 142. The first arm 141 extends forward of the actuator 130A (positive direction of the Y-axis) and is engaged in the elongated hole 132b of the base portion 132. The second arm 142 extends rearward of the actuator 130A (negative direction of the Y-axis).

As illustrated in FIG. 5, the first cam 140A disposed below the rear portion of the actuator 130A has a third arm 143 and a fourth arm 144. The third arm 143 extends rearward of the actuator 130A (negative direction of the Y-axis) and is engaged in the elongated hole 132b of the base portion 132. The fourth arm 144 extends forward of the actuator 130A (positive direction of the Y-axis).

More specifically, the first cam 140A disposed below the front portion of the actuator 130A has an engagement protruding portion 141a at the distal end of the first arm 141 for engaging with the elongated hole 132b formed at one side in the width direction W at the front end portion of the base portion 132. The first cam 140A disposed below the rear portion of the actuator 130A has an engagement protruding portion 143a at the distal end of the third arm 143 for engaging with the elongated hole 132b formed at the other side of the width direction W at the rear end portion of the base portion 132.

As described above, the first cams 140A engage with the respective elongated holes 132b formed in the actuator 130A and extending in the front-rear direction (the longitudinal direction L) of the actuator 130A in such a manner that the first cams 140A are rotated by pressing down or pulling up the front or rear end portion of the actuator 130A. In the present embodiment, the elongated holes 132b of the actuator 130A for engaging the first cams 140A are formed, for example, at the respective front and rear portions of the actuator 130A.

As illustrated in FIG. 4, the case 110 rotatably supports the second cam 140B by the second cam support 112 of the upper case 110A, for example. Specifically, as illustrated in FIGS. 3 and 5, the second cam 140B has a cylindrical rotating shaft projecting in the width direction W at its center. As illustrated in FIG. 4, the second cam support 112 has a recessed groove formed at the center of the upper case 110A and a shaft support provided at a lower edge of the recessed groove. The shaft support of the second cam support 112 is a pair of arc-shaped cutouts formed at the lower edges of the side walls of the recessed groove that intersects the width direction W.

The second cam 140B is inserted, for example, into the recessed groove of the second cam support portion 112 from below the upper case 110A, and the cylindrical rotating shaft provided at the center of the second cam 140B is received in the arc-shaped cutouts formed at the respective lower edges of the side walls of the recessed groove of the second cam support 112. The case 110 thereby rotatably supports the second cam 140B by, for example, the second cam support 112 of the upper case 110A about a rotating shaft parallel to the width direction W orthogonal to the longitudinal direction L (front-rear direction) and the height direction H of the switch device 100. The configuration in which the second cam 140B is rotatably supported by the case 110 is not limited to the configuration illustrated in the drawing, and any configuration may be adopted.

The second cam support 112 for supporting the second cam 140B is provided at the center of the upper case 110A as illustrated in FIG. 4. Thus, the second cam 140B is arranged at a position corresponding to the central portion of the actuator 130A in the front-rear direction (longitudinal direction L) as illustrated in FIG. 5. As illustrated in FIG. 5, the tilt slider 132a arranged in the lower portion of the actuator 130A has a recess 132d. The recess 132d is formed in the center of the lower surface of the tilt slider 132a arranged in the lower portion of the base portion 132 of the actuator 130A.

The second cam 140B has a fifth arm 145 extending forward (in the positive direction of the Y-axis) and a sixth arm 146 extending rearward (in the negative direction of the Y-axis). The second cam 140B also has an engaging portion 147 extending upward in the height direction H (in the positive direction of the Z-axis) and having a distal end engaged in the recess 132d formed in the base portion 132 of the actuator 130A.

The distal end of the engaging portion 147 of the second cam 140B has, for example, a bowl-shaped recess with an open upper end. The bottom of the recess 132d formed in the tilt slider 132a arranged in the lower portion of the actuator 130A has a protruding portion that is received in the recess of the distal end of the engaging portion 147. The distal end of the engaging portion 147 of the second cam 140B and the recess 132d formed in the lower portion of the actuator 130A are loosely engaged with each other with a gap so as to allow the tilt slider 132a to rock back and force in accordance with an operation of the actuator 130A.

As described above, the second cam 140B is engaged with the actuator 130A so as to rotate due to the movement of the actuator 130A in the front-rear direction (the longitudinal direction L). Specifically, the second cam 140B is engaged in the recess 132d formed in the lower portion of the actuator 130A. Instead of the recess 132d, the actuator 130A may have a structure such as a protruding portion for engaging the second cam 140B.

The plurality of plungers 150 are accommodated in, for example, recesses or vertical holes formed in the upper case 110A of the case 110 illustrated in FIGS. 3 and 4, and are supported movably in the vertical direction (the height direction H). The lower end of each plunger 150 is arranged above, for example, a corresponding one of the plurality of movable contacts 161 provided on the elastic sheet 160 as illustrated in FIG. 5. The plurality of plungers 150 can be individually pressed down by the rotation of the first cam 140A or the second cam 140B.

Specifically, the plurality of plungers 150 includes, for example, the first plunger 151 through the sixth plunger 156 corresponding to the first arm 141 through the sixth arm 146 of the first cams 140A and the second cam 140B, respectively.

More specifically, the first plunger 151 is arranged under the first arm 141 of the first cam 140A disposed below the front portion of the actuator 130A, and is pressed down by the first arm 141 as the first cam 140A rotates forward. The forward rotation of the front-side first cam 140A illustrated in FIG. 5 is a counterclockwise rotation of the first cam 140A.

The second plunger 152 is arranged under the second arm 142 of the first cam 140A disposed below the front portion of the actuator 130A, and is pressed down by the second arm 142 as the first cam 140A rotates rearward. The rearward rotation of the front-side first cam 140A illustrated in FIG. 5 is a clockwise rotation of the first cam 140A.

The third plunger 153 is arranged under the third arm 143 of the first cam 140A disposed below the rear portion of the actuator 130A, and is pressed down by the third arm 143 as the first cam 140A rotates rearward. The rearward rotation of the rear-side first cam 140A illustrated in FIG. 5 is a clockwise rotation of the first cam 140A.

The fourth plunger 154 is arranged under the fourth arm 144 of the first cam 140A disposed below the rear portion of the actuator 130A, and is pressed down by the fourth arm 144 as the first cam 140A rotates forward. The forward rotation of the rear-side first cam 140A illustrated in FIG. 5 is a counterclockwise rotation of the first cam 140A.

The fifth plunger 155 is arranged under the fifth arm 145 of the second cam 140B disposed below the central portion of the actuator 130A in the front-rear direction, and is pressed down by the fifth arm 145 as the second cam 140B rotates forward. The forward rotation of the second cam 140B illustrated in FIG. 5 is a counterclockwise rotation of the second cam 140B.

The sixth plunger 156 is arranged under the sixth arm 146 of the second cam 140B disposed below the central portion of the actuator 130A in the front-rear direction, and is pressed down by the sixth arm 146 as the second cam 140B rotates rearward. The rearward rotation of the second cam 140B illustrated in FIG. 5 is a clockwise rotation of the second cam 140B.

Each of the plurality of movable contacts 161 can be pressed down by a corresponding one of the plurality of corresponding plungers 150. As described above, the plurality of movable contacts 161 are provided on the elastic sheet 160. In this configuration, each movable contact 161 is elastically pressed down by its corresponding plunger 150. For example, as illustrated in FIG. 3, the elastic sheet 160 is a rubber sheet formed in a substantially rectangular shape corresponding to the shape of the printed wiring board 170 and having elasticity, and is arranged facing the printed wiring board 170. The plurality of movable contacts 161 need not be elastically deformable as long as they can be pressed down individually by the respective corresponding plungers 150.

As illustrated in FIG. 3, the plurality of fixed contacts 171 are provided opposed to the plurality of movable contacts 161, respectively. The plurality of fixed contacts 171 are provided on the printed wiring board 170 as described above.

Each of the movable contacts 161 includes, for example, a bulging portion provided on the elastic sheet 160 and a metallic conductive portion provided inside the bulging portion facing a corresponding fixed contact 171. The bulging portion of the movable contact 161 is formed by, for example, causing a portion of the elastic sheet 160 facing the fixed contact 171 to bulge in a direction opposite to the fixed contact 171. The conductive portion of the movable contacts 161 is provided inside the top portion of the bulging portion and faces the fixed contact 171.

With this configuration, when a force for pressing down the movable contacts 161 toward the fixed contacts 171 acts on the plungers 150, the bulging portions of the movable contacts 161 are elastically deformed, and the conductive portions contact the fixed contacts 171, thereby short-circuiting the fixed contacts 171. When the force for pressing down the movable contacts 161 toward the fixed contacts 171 ceases to act on the plungers 150, the bulging portions of the elastically deformed movable contacts 161 are restored, and the plungers 150 are pushed up to the original positions, thereby releasing the fixed contacts 171.

More specifically, the plurality of movable contacts 161 includes a first movable contact 161a through a sixth movable contact 161f corresponding to a first plunger 151 through a sixth plunger 156, respectively. The plurality of fixed contacts 171 include a first fixed contact 171a through a sixth fixed contact 171f corresponding to a first movable contact 161a through a sixth movable contact 161f, respectively.

When the first cam 140A disposed below the front portion of the actuator 130A rotates forward and the first plunger 151 is pressed down by the first arm 141, the bulging portion of the first movable contact 161a subjected to the force from the first plunger 151 is elastically deformed toward the first fixed contact 171a. As a result, the conductive portion of the first movable contact 161a comes into contact with the first fixed contact 171a to short-circuit the first fixed contact 171a.

In the second movable contact 161b, when the first cam 140A disposed below the front portion of the actuator 130A rotates rearward and the second plunger 152 is pressed down by the second arm 142, the bulging portion subjected to the force from the second plunger 152 elastically deforms toward the second fixed contact 171b. As a result, the conductive portion of the second movable contact 161b comes into contact with the second fixed contact 171b to short-circuit the second fixed contact 171b.

In the third movable contact 161c, when the first cam 140A disposed below the rear portion of the actuator 130A rotates rearward and the third plunger 153 is pressed down by the third arm 143, the bulging portion subjected to the force from the third plunger 153 elastically deforms toward the third fixed contact 171c. As a result, the conductive portion of the third movable contact 161c comes into contact with the third fixed contact 171c to short-circuit the third fixed contact 171c.

In the fourth movable contact 161d, when the first cam 140A disposed below the rear portion of the actuator 130A rotates forward and the fourth plunger 154 is pressed down by the fourth arm 144, the bulging portion subjected to the force from the fourth plunger 154 elastically deforms toward the fourth fixed contact 171d. As a result, the conductive portion of the fourth movable contact 161d comes into contact with the fourth fixed contact 171d to short-circuit the fourth fixed contact 171d.

In the fifth movable contact 161e, when the second cam 140B disposed below the central portion of the actuator 130A rotates forward and the fifth plunger 155 is pressed down by the fifth arm 145, the bulging portion subjected to the force from the fifth plunger 155 elastically deforms toward the fifth fixed contact 171e. As a result, the conductive portion of the fifth movable contact 161e comes into contact with the fifth fixed contact 171e to short-circuit the fifth fixed contact 171e.

In the sixth movable contact 161f, when the second cam 140B disposed below the central portion of the actuator 130A rotates rearward and the sixth plunger 156 is pressed down by the sixth arm 146, the bulging portion subjected to the force from the sixth plunger 156 elastically deforms toward the sixth fixed contact 171f. As a result, the conductive portion of the sixth movable contact 161f comes into contact with the sixth fixed contact 171f to short-circuit the sixth fixed contact 171f.

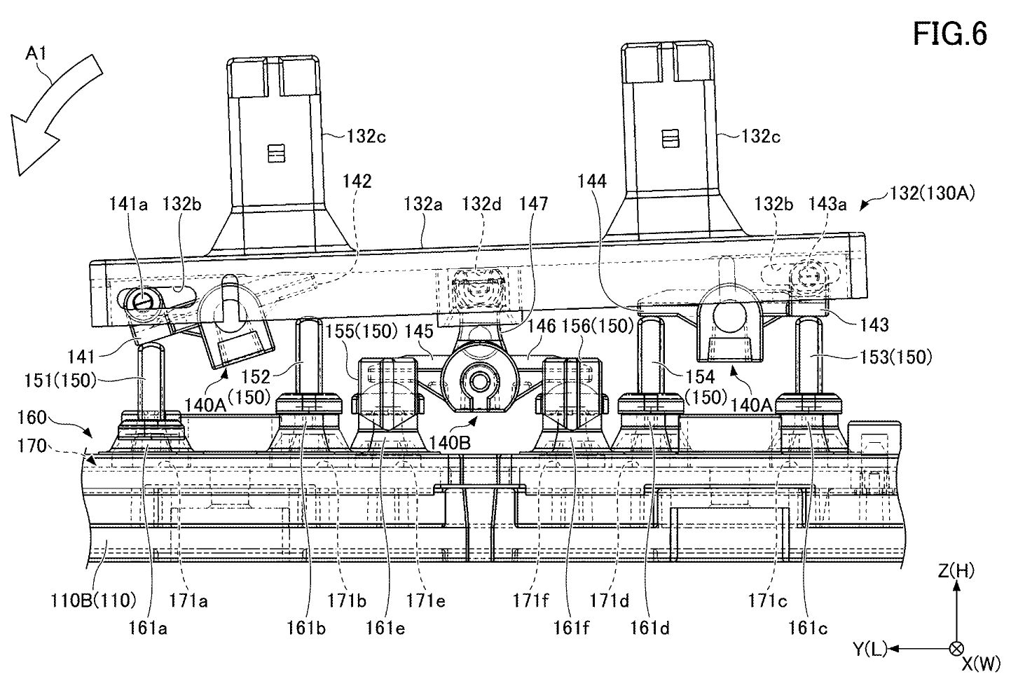

Hereinafter, the specific operation of the switch device 100 will be described with reference to FIGS. 6 to 8. In FIGS. 6 through 8, as in FIG. 5, the first cams 140A and the second cam 140B are rotatably supported by the first cam supports 111 and the second cam support 112 of the upper case 110A (not illustrated). Each of the plurality of plungers 150 is accommodated in a recess or a vertical hole formed in the upper case 110A (not illustrated) and is supported so as to be movable up and down.

FIG. 6 is a side view illustrating a state when the front end of the operation knob 131 is pressed down in the actuator 130A illustrated in FIG. 2. The front end of the operation knob 131 of the actuator 130A illustrated in FIG. 2 is pressed down as indicated by an arrow A1 in FIG. 6. Then, the base portion 132 of the actuator 130A rocks from a state parallel to the upper surface of the case 110 illustrated in FIGS. 2 and 5 to be tilted forward as illustrated in FIG. 6. As a result, the first cam 140A that is disposed below the front portion of the actuator 130A and engaged with the elongated hole 132b formed in the front end portion of the actuator 130A rotates forward.

When the front end portion of the actuator 130A is pressed down, the rocking support portions 113 provided on the case 110 illustrated in FIGS. 2 through 4 abut against the lower surface of the tilt slider 132a arranged in the lower portion of the actuator 130A to support the actuator 130A in a rockable manner. When the front end portion of the actuator 130A is pressed farther down, the rocking regulating portion 114 provided on the front portion of the case 110 illustrated in FIGS. 3 and 4 abuts against the lower surface of the tilt slider 132a arranged in the lower portion of the actuator 130A to regulate the rocking of the actuator 130A.

When the front end portion of the actuator 130A illustrated by arrow A1 in FIG. 6 is pressed down, the first cam 140A disposed below the rear portion of the actuator 130A allows the actuator 130A to rock with the engagement protruding portion 143a of the third arm 143 engaged with the elongated hole 132b formed in the rear portion of the actuator 130A as a fulcrum. Thus, the first cam 140A disposed below the rear portion of the actuator 130A does not rotate. Similarly, the second cam 140B disposed below the central portion of the actuator 130A allows the actuator 130A to rock with the tip of the engaging portion 147 that is received in the recess 132d formed in the central portion of the actuator 130A as a fulcrum. As a result, the second cam 140B disposed below the central portion of the actuator 130A also does not rotate.

As described above, when the front end portion of the actuator 130A is pressed down, only the first cam 140A disposed below the front portion of the actuator 130A rotates forward, and the first plunger 151 is thereby selectively pressed down by the first arm 141 of the first cam 140A. As a result, the first plunger 151 moves the first movable contact 161a toward the first fixed contact 171a, thereby selectively bringing the first movable contact 161a into contact with the first fixed contact 171a, and thereby selectively short-circuiting the first fixed contact 171a.

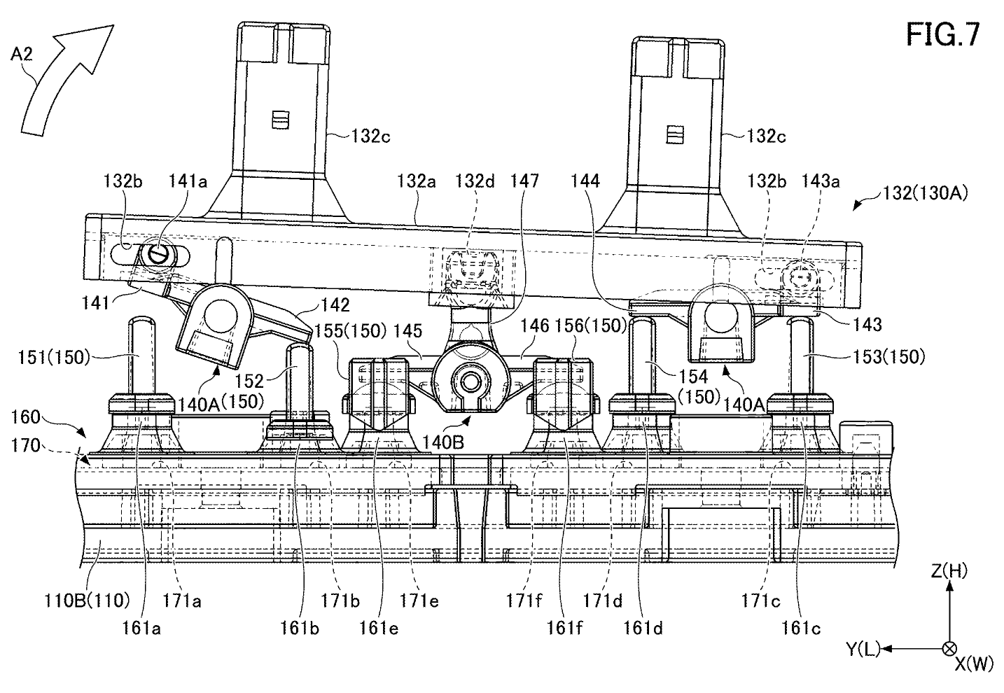

FIG. 7 is a side view illustrating a state of the actuator 130A illustrated in FIG. 2 when the front end portion of the operation knob 131 is pulled up. The front end of the operation knob 131 of the actuator 130A illustrated in FIG. 2 is pulled up as indicated by an arrow A2 in FIG. 7. As a result, the base portion 132 of the actuator 130A rocks from a state parallel to the upper surface of the case 110 illustrated in FIGS. 2 and 5 so as to be tilted backward as illustrated in FIG. 7. As a result, the first cam 140A that is disposed below the front portion of the actuator 130A and engaged with the elongated hole 132b formed in the front portion of the actuator 130A rotates rearward.

When the front end portion of the actuator 130A is pulled up as illustrated by the arrow A2 in FIG. 7, the first cam 140A disposed below the rear portion of the actuator 130A allows the actuator 130A to rock with the engagement protruding portion 143a of the third arm 143 engaged with the elongated hole 132b formed in the rear portion of the actuator 130A as the fulcrum. As a result, the first cam 140A disposed below the rear portion of the actuator 130A does not rotate. A tip of the engaging portion 147 of the second cam 140B is shallowly received in the recess 132d formed in the central portion of the actuator 130, thereby allowing the actuator 130A to rock. As a result, the second cam 140B disposed below the central portion of the actuator 130A also does not rotate.

As described above, when the front end portion of the actuator 130A is pulled up, only the first cam 140A disposed below the front portion of the actuator 130A rotates rearward, and the second plunger 152 is thereby selectively pressed down by the second arm 142 of the first cam 140A. As a result, the second plunger 152 moves the second movable contact 161b toward the second fixed contact 171b, thereby selectively bringing the second movable contact 161b into contact with the second fixed contact 171b, and thereby selectively short-circuiting the second fixed contact 171b.

Although not illustrated, when the rear end portion of the actuator 130A is pressed down, the base portion 132 of the actuator 130A rocks so as to be tilted backward, contrary to the example illustrated in FIG. 6. As a result, the first cam 140A that is disposed below the rear portion of the actuator 130A and engaged with the elongated hole 132b formed in the rear end portion of the actuator 130A rotates rearward.

When the rear end portion of the actuator 130A is pressed down, the rocking support portions 113 provided on the case 110 illustrated in FIGS. 3 and 4 abut against the lower surface of the tilt slider 132a arranged in the lower portion of the actuator 130A to support the actuator 130A in a rockable manner. When the rear end portion of the actuator 130A is pressed farther down, the rocking regulating portion 114 provided on the rear portion of the case 110 illustrated in FIGS. 2 through 4 abuts against the lower surface of the tilt slider 132a arranged in the lower portion of the actuator 130A to regulate the rocking of the actuator 130A.

Contrary to when the front end portion of the actuator 130A is pressed down, when the rear end portion of the actuator 130A is pressed down, the first cam 140A disposed below the front portion of the actuator 130A does not rotate. Similarly to when the front end portion of the actuator 130A is pressed down, the second cam 140B disposed below the central portion of the actuator 130A also does not rotate.

As described above, when the rear end portion of the actuator 130A is pressed down, only the first cam 140A disposed below the rear portion of the actuator 130A rotates rearward, the third plunger 153 is thereby selectively pressed down the third arm 143 of the first cam 140A. As a result, the third plunger 153 moves the third movable contact 161c toward the third fixed contact 171c, thereby selectively bringing the third movable contact 161c into contact with the third fixed contact 171c and selectively short-circuiting the third fixed contact 171c.

When the rear end portion of the actuator 130A is pulled up, the base portion 132 of the actuator 130A rocks so as to be tilted forward, contrary to the example illustrated in FIG. 7. As a result, the first cam 140A that is disposed below the rear portion of the actuator 130A and engaged with the elongated hole 132b formed in the rear end portion of the actuator 130A rotates forward.

When the rear end portion of the actuator 130A is pulled up, the first cam 140A disposed below the front portion of the actuator 130A allows the actuator 130A to rock with the engagement protruding portion 141a of the first arm 141 engaged with the elongated hole 132b formed in the front portion of the actuator 130A as a fulcrum. As a result, the first cam 140A disposed below the front portion of the actuator 130A does not rotate. A tip of the engaging portion 147 of the second cam 140B is shallowly engaged in the recess 132d formed in the central portion of the actuator 130A, thereby allowing the actuator 130A to rock. As a result, the second cam 140B disposed below the central portion of the actuator 130A also does not rotate.

As described above, when the rear end portion of the actuator 130A is pulled up, only the first cam 140A disposed below the rear portion of the actuator 130A rotates forward, and the fourth plunger 154 is thereby selectively pressed down by the fourth arm 144 of the first cam 140A. As a result, the fourth plunger 154 moves the fourth movable contact 161d toward the fourth fixed contact 171d, selectively brings the fourth movable contact 161d into contact with the fourth fixed contact 171d, and selectively short-circuits the fourth fixed contact 171d.

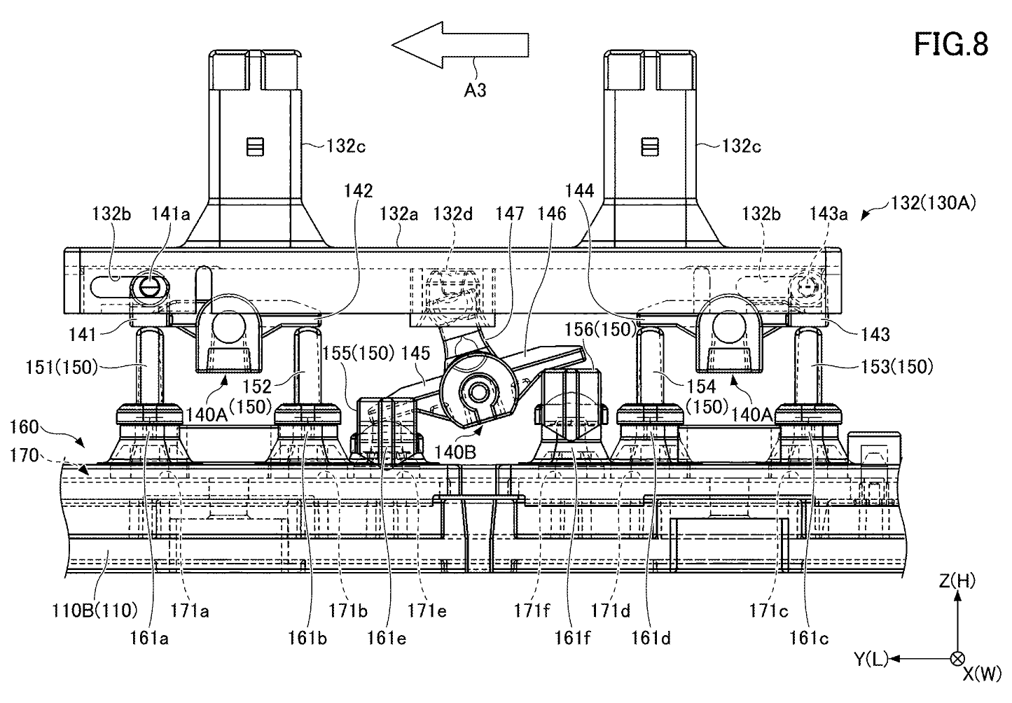

FIG. 8 is a side view illustrating a state when the operation knob 131 is translated forward in the actuator 130A illustrated in FIG. 2. The operation knob 131 of the actuator 130A illustrated in FIG. 2 is translated forward as indicated by an arrow A3 in FIG. 8. Then, the base portion 132 of the actuator 130A moves from the initial position illustrated in FIGS. 2 and 5 to the forward sliding position illustrated in FIG. 8. In accordance with the forward translational movement of the base portion 132, the second cam 140B in which the tip of the engaging portion 147 is engaged in the recess 132d formed in the lower portion of the actuator 130A rotates forward.

When the actuator 130A is translated forward as indicated by the arrow A3 in FIG. 8, the first cams 140A disposed below the front and rear portions of the actuator 130A permit a translational movement of the base portion 132 along the elongated holes 132b formed in the tilt slider 132a arranged in the lower portion of the actuator 130A. Thus, the first cams 140A disposed below the front and rear portions of the actuator 130A do not rotate.

As described above, when the actuator 130A is translated forward, only the second cam 140B disposed below the central portion of the actuator 130A rotates forward, and the fifth plunger 155 is thereby selectively pressed down by the fifth arm 145 of the second cam 140B. As a result, the fifth plunger 155 moves the fifth movable contact 161e toward the fifth fixed contact 171e to selectively bring the fifth movable contact 161e into contact with the fifth fixed contact 171e, thereby selectively short-circuiting the fifth fixed contact 171e.

Although not illustrated, when the actuator 130A is translated rearward, the base portion 132 of the actuator 130A is moved from the initial position illustrated in FIGS. 2 and 5 to a position that slides rearward opposite to the example illustrated in FIG. 8. As the base portion 132 is translated rearward, the second cam 140B in which the tip of the engaging portion 147 is engaged in the recess 132d formed in the lower portion of the actuator 130A rotates rearward.

When the actuator 130A is translated rearward opposite to the arrow A3 illustrated in FIG. 8, the first cams 140A disposed below the front and rear portions of the actuator 130A permit a translational movement of the base portion 132 along the elongated hole 132b formed in the tilt slider 132a arranged in the lower portion of the actuator 130A. As a result, the first cams 140A disposed below the front and rear portions of the actuator 130A do not rotate.

As described above, when the actuator 130A is translated rearward, only the second cam 140B disposed below the central portion of the actuator 130A rotates rearward, and the sixth plunger 156 is thereby selectively pressed down by the sixth arm 146 of the second cam 140B. As a result, the sixth plunger 156 moves the sixth movable contact 161f toward the sixth fixed contact 171f, thereby selectively bringing the sixth movable contact 161f and the sixth fixed contact 171f into contact with each other and selectively short-circuiting the sixth fixed contact 171f.

Hereinafter, advantageous effects of the switch device 100 of the present embodiment will be described.

As described above, the conventional switch device capable of accepting a rocking operation of the actuator cannot accept a translational operation of the actuator, and vice versa. Therefore, it has been necessary to separately provide a switch device configured for rocking operation and a switch device configured for translational operation.

On the other hand, the switch device 100 of the present embodiment includes the actuator 130A, the first cam 140A, the second cam 140B, the plurality of plungers 150, the plurality of movable contacts 161, and the plurality of fixed contacts 171. The first cam 140A is engaged with an elongated hole 132b formed in the actuator 130A and extending in the front-rear direction of the actuator 130A, and is configured to rotate when the front end portion or the rear end portion of the actuator 130A is pressed down or pulled up. The second cam 140B is engaged with the actuator 130A and configured to rotate upon a movement of the actuator 130A in the front-rear direction. The plurality of plungers 150 are configured to be individually pressed down in response to rotation of the first cam or the second cam. Each of the plurality of movable contacts 161 is configured to be pressed down by a corresponding one of the plurality of plungers 150. Each of the plurality of fixed contacts 171 is provided opposed to a corresponding one of the plurality of movable contacts 161.

With this configuration, when the front end portion or the rear end portion of the actuator 130A is pressed down, the first cam 140A that is disposed below the pressed down end portion and engaged with the elongated hole 132b rotates forward or rearward about a rotation axis parallel to the width direction W. On the other hand, the second cam 140B engaged with the actuator 130A does not rotate because the second cam 140B allows the actuator 130A to rock, which is caused by the pressing-down of the front end portion or the rear end portion of the actuator 130A. Therefore, when the front end portion or the rear end portion of the actuator 130A is pressed down, one plunger 150 is selectively pressed down by the forward or rearward rotation of the first cam 140A disposed below the pressed down end portion. Furthermore, one movable contact 161 corresponding to the pressed plunger 150 is pressed down and comes into contact with one fixed contact 171 opposed to the movable contact 161, thereby selectively short-circuiting the fixed contact 171.

Similarly, when the front end portion or the rear end portion of the actuator 130A is pulled up, the first cam 140A that is disposed below the pulled-up end portion and engaged with the elongated hole 132b rotates in a direction opposite to when the actuator 130A is pressed down. On the other hand, the second cam 140B engaged with the actuator 130A does not rotate because the second cam 140B allows the actuator 130A to rock, which is caused by the pulling-up of the front end portion or the rear end portion of the actuator 130A. Therefore, when the front end portion or the rear end portion of the actuator 130A is pulled up, another plunger 150 is selectively pressed down by the forward or rearward rotation of the first cam 140A disposed below the pulled-up end portion about the rotation axis parallel to the width direction W. Furthermore, another movable contact 161 corresponding to the pressed plunger 150 is pressed down and comes into contact with another fixed contact 171 opposed to the movable contact 161, thereby selectively short-circuiting the fixed contact 171.

When the actuator 130A is translated forward, the second cam 140B engaged with the actuator 130A rotates forward about the rotation axis parallel to the width direction W. On the other hand, the first cam 140A engaged with the elongated hole 132b extending in the front-rear direction of the actuator 130A does not rotate because the first cam 140A allows a forward translational movement of the actuator 130A. Therefore, when the actuator 130A is translated forward, yet another plunger 150 is selectively pressed down in response to the forward rotation of the second cam 140B. Yet another movable contact 161 corresponding to the pressed plunger 150 is pressed down and comes into contact with yet another fixed contact 171 opposed to the movable contact 161, thereby selectively short-circuiting the fixed contact 171.

Similarly, when the actuator 130A is translated rearward, the second cam 140B engaged with the actuator 130A rotates forward about the rotation axis parallel to the width direction W. On the other hand, the first cam 140A engaged with the elongated hole 132b extending in the front-rear direction of the actuator 130A does not rotate because the first cam 140A allows a rearward translational movement of the actuator 130A. Therefore, when the actuator 130A is translated rearward, yet another plunger 150 is selectively pressed down in response to the rearward rotation of the second cam 140B. Yet another movable contact 161 corresponding to the pressed plunger 150 is pressed down and comes into contact with yet another fixed contact 171 opposed to the movable contact 161, thereby selectively short-circuiting the fixed contact 171.

Therefore, according to the switch device 100 of the present embodiment, it is possible to accept an operation in which the actuator 130A is rocked by pressing down or pulling up the front or rear end portion of the actuator 130A and an operation in which the actuator 130A is translated in the front-rear direction. The switch device 100 is configured to selectively short-circuit at least four fixed contacts 171 in response to (i) pressing-down of the front or rear end portion of the actuator 130A, (ii) pulling-up of the front or rear end portion of the actuator 130A, (iii) forward translational movement of the actuator 130A, and (iv) rearward translational movement of the actuator 130A, thereby detecting at least four types of operation inputs.

In the switch device 100 of the present embodiment, the first cam 140A is arranged at each of a position corresponding to the front portion of the actuator 130A and a position corresponding to the rear portion of the actuator 130A, and the second cam 140B is arranged at a position corresponding to the central portion of the actuator 130A in the front-rear direction.

With this configuration, when the front end portion of the actuator 130A is pressed down, the first cam 140A that is disposed below the front portion of the actuator 130A and engaged with the elongated hole 132b rotates forward. On the other hand, the first cam 140A that is disposed below the rear portion of the actuator 130A and engaged with the elongated hole 132b and the second cam 140B engaged in the recess 132d formed in the lower portion of the actuator 130A do not rotate because the first cam 140A and the second cam 140B allow the actuator 130A to rock, which is caused by the pressing-down of the front end portion of the actuator 130A. Therefore, when the front end portion of the actuator 130A is pressed down, one plunger 150 is selectively pressed down by the forward rotation of the first cam 140A disposed below the front portion of the actuator 130A. Furthermore, one movable contact 161 corresponding to the pressed plunger 150 is pressed down and comes into contact with one fixed contact 171 opposed to the movable contact 161, thereby selectively short-circuiting the fixed contact 171.

Similarly, when the front end portion of the actuator 130A is pulled up, the first cam 140A that is disposed below the front portion of the actuator 130A and engaged with the elongated hole 132b rotates rearward. On the other hand, the first cam 140A that is disposed below the rear portion of the actuator 130A and engaged with the elongated hole 132b and the second cam 140B engaged in the recess 132d formed in the lower portion of the actuator 130A do not rotate because the first cam 140A and the second cam 140B allow the actuator 130A to rock, which is caused by the pulling-up of the front end portion of the actuator 130A. Therefore, when the front end portion of the actuator 130A is pulled up, another plunger 150 is selectively pressed down by the forward rotation of the first cam 140A disposed below the front portion of the actuator 130A. Furthermore, another movable contact 161 corresponding to the pressed plunger 150 is pressed down and comes into contact with another fixed contact 171 opposed to the movable contact 161, thereby selectively short-circuiting the fixed contact 171.

When the rear end portion of the actuator 130A is pressed down, the first cam 140A that is disposed below the rear portion of the actuator 130A and engaged with the elongated hole 132b rotates rearward. On the other hand, the first cam 140A that is disposed below the front portion of the actuator 130A and engaged with the elongated hole 132b and the second cam 140B engaged in the recess 132d formed in the lower portion of the actuator 130A do not rotate because the first cam 140A and the second cam 140B allow the actuator 130A to rock, which is caused by the pressing-down of the rear end portion of the actuator 130A. Therefore, when the rear end portion of the actuator 130A is pressed down, yet another plunger 150 is selectively pressed down by the rearward rotation of the first cam 140A disposed below the rear portion of the actuator 130A. Furthermore, yet another movable contact 161 corresponding to the pressed plunger 150 is pressed down and comes into contact with yet another fixed contact 171 opposed to the movable contact 161, thereby selectively short-circuiting the fixed contact 171.

Similarly, when the rear end portion of the actuator 130A is pulled up, the first cam 140A that is disposed below the rear end portion of the actuator 130A and engaged with the elongated hole 132b rotates forward. On the other hand, the first cam 140A that is disposed below the front portion of the actuator 130A and engaged with the elongated hole 132b and the second cam 140B engaged in the recess 132d formed in the lower portion of the actuator 130A do not rotate because the first cam 140 and the second cam 140B allow the actuator 130A to rock, which is caused by the pulling-up of the rear end portion of the actuator 130A. Therefore, when the rear end portion of the actuator 130A is pulled up, yet another plunger 150 is selectively pressed down by the forward rotation of the first cam 140A disposed below the rear portion of the actuator 130A. Furthermore, yet another movable contact 161 corresponding to the pressed plunger 150 is pressed down and comes into contact with yet another fixed contact 171 opposed to the movable contact 161, thereby selectively short-circuiting the fixed contact 171.

Therefore, according to the switch device 100 of the present embodiment, the switch device 100 is configured to selectively short-circuit at least six fixed contacts 171 in response to (i) pressing-down and pulling-up of the front end portion of the actuator 130A, (ii) pressing-down and pulling-up of the rear end portion of the actuator 130A, and (iii) forward and rearward translational movement of the actuator 130A, thereby detecting at least six types of operation inputs.

In the switch device 100 of the present embodiment, the actuator 130A includes the operation knob 131, the base portion 132 connected to the lower portion of the operation knob 131, and the recess 132d formed in the central portion of the lower portion of the base portion 132 and configured to engage with the second cam 140B. One elongated hole 132b is located at one side in the width direction W at the front end portion of the tilt slider 132a, and the other elongated hole 132b is located at the opposite side in the width direction W at the rear end portion of the tilt slider 132a.

With this configuration, the first cam 140A disposed below the front portion of the actuator 130A can be engaged with the elongated hole 132b formed at one end in the width direction W at the front end portion of the base portion 132 included in the actuator 130A. The second cam 140B disposed below the rear portion of the actuator 130A can be engaged in the elongated hole 132b formed at the other end in the width direction W at the rear end portion of the base portion 132 included in the actuator 130A. Furthermore, the second cam 140B can be engaged in the recess 132d between the two first cams 140A in the front-rear direction (longitudinal direction L) and width direction W of the actuator 130A. Thus, the base portion 132 is supported by the two first cams 140A and the one second cam 140B in a balanced manner, and the operation knob 131 can be stably operated.

In the switch device 100 of the present embodiment, the first cam 140A disposed below the front portion of the actuator 130A includes the first arm 141 extending forward of the actuator 130A and configured to engage with the elongated hole 132b formed in the front end portion of the base 131, and the second arm 142 extending rearward of the actuator 130A. The first cam disposed below the rear portion of the actuator 130A includes the third arm 143 extending rearward of the actuator 130A and configured to engage with the elongated hole 132b formed in the rear end portion of the base 131, and the fourth arm 144 extending forward of the actuator 130A. The second cam 140B includes the fifth arm 145 extending forward of the actuator 130A, the sixth arm 146 extending rearward of the actuator 130A, and the engaging portion 147 extending upward of the actuator 130A and having the distal end engaged in the recess 132d. The plurality of plungers 150 include the first plunger 151 through the sixth plunger 156 corresponding to the first arm 141 through the sixth arm 146. The plurality of movable contacts 161 include the first movable contact 161a through the sixth movable contact 161f corresponding to the first plunger 151 through the sixth plunger 156. The plurality of fixed contacts 171 include the first fixed contact 171a through the sixth fixed contact 171f corresponding to the first movable contact 161a through the sixth movable contact 161f.

With this configuration, when the front end portion of the actuator 130A is pressed down, the first cam 140A disposed below the front portion of the actuator 130A rotates forward, the first plunger 151 is pressed down by the first arm 141, and the first movable contact 161a short-circuits the first fixed contact 171a. When the front end portion of the actuator 130A is pulled up, the first cam 140A disposed below the front portion of the actuator 130A rotates rearward, the second plunger 152 is pressed down by the second arm 142, and the second movable contact 161b short-circuits the second fixed contact 171b.

When the rear end portion of the actuator 130A is pressed down, the first cam 140A disposed below the rear portion of the actuator 130A rotates rearward, the third plunger 153 is pressed down by the third arm 143, and the third movable contact 161c short-circuits the third fixed contact 171c. When the rear end portion of the actuator 130A is pulled up, the first cam 140A disposed below the rear portion of the actuator 130A rotates forward, the fourth plunger 154 is pressed down by the fourth arm 144, and the fourth movable contact 161d short-circuits the fourth fixed contact 171d.

When the actuator 130A is translated forward, the second cam 140B disposed below the central portion of the actuator 130A rotates forward, the fifth plunger 155 is pressed down by the fifth arm 145, and the fifth movable contact 161e short-circuits the fifth fixed contact 171e. When the actuator 130A is translated rearward, the second cam 140B disposed below the central portion of the actuator 130A rotates rearward, the sixth plunger 156 is pressed down by the sixth arm 146, and the sixth movable contact 161f short-circuits the sixth fixed contact 171f.

As described above, according to the switch device 100 of the present embodiment, the switch device 100 is configured to individually short-circuit the first fixed contact 171a and the sixth fixed contact 171f in response to (i) pressing-down and pulling-up of the front end portion of the actuator 130A, (ii) pressing-down and pulling-up of the rear end portion of the actuator 130A, and (iii) forward and rearward translational movement of the actuator 130A, thereby detecting at least six types of operation inputs.

The switch device 100 of the present embodiment further includes the case 110 configured to rotatably support the first cams 140A and the second cam 140B.

With this configuration, the case 110 can accommodate the components of the switch device 100 and rotatably support the first cams 140A and the second cam 140B, and the actuator 130A can be arranged above the first cams 140A and the second cam 140B. Therefore, according to the switch device 100 of the present embodiment, the device can be miniaturized, and can be easily installed in a limited space, for example, in the cabin of an automobile.

In the switch device 100 of the present embodiment, the case 110 includes the rocking support portions 113 configured to support the actuator 130A in a rockable manner by abutting against the lower portion of the actuator 130A when the front or rear end portion of the actuator 130A is pressed down.

With this configuration, the actuator 130A can be stably rocked by pressing down the front end portion or the rear end portion of the actuator 130A, and it is possible to suppress excessive stress from acting on the first cams 140A and the second cam 140B. As described above, the rocking regulating portions 114 having a smaller dimension in the height direction H than the rocking support portions 113 may be provided adjacent to the rocking support portions 113 respectively closer to the front and rear end portions of the actuator 130A. In this configuration, the rocking regulating portions 114 suppress excessive rocking of the actuator 130A, and it is possible to suppress excessive stress from acting on the first cams 140A and the second cam 140B.

The switch device 100 of the present embodiment further includes the elastic sheet 160 provided with the plurality of movable contacts 161.

With this configuration, the elastic sheet 160 can be provided with a bulging portion, and the movable contact 161 can be provided on the bulging portion. Thus, after the movable contact 161 is pressed down by the plunger 150, elastic force for returning the movable contact 161 to the original position can be suppressed. When the actuator 130A is not operated, the respective plungers 150 can be supported by the respective movable contacts 161. Thus, the first cams 140A and the second cam 140B can be supported by the respective plungers 150, and the actuator 130A can be stably supported at the initial position when not operated by the first cams 140A and the second cam 140B.

The switch device 100 of this embodiment further includes the printed wiring board 170 provided with the plurality of fixed contacts 171.

With this configuration, when the respective movable contacts 161 contact the respective fixed contacts 171 thereby short-circuiting the respective fixed contacts 171, the short-circuiting of the respective fixed contacts 171 can be detected by an electronic circuit provided in the printed wiring board 170. Thus, a signal corresponding to the operation of the actuator 130A can be externally output by the electronic circuit of the printed wiring board 170.

As described above, according to the present embodiment, it is possible to provide the switch device 100 configured to accept a rocking operation of the actuator 130A and a translational operation of the actuator 130A.

The embodiments of the switch device according to the present disclosure have been described in detail. However, the switch device according to the present disclosure is not limited to the above-described embodiments. Various alterations or substitutions may be applied to the above-described embodiments without departing from the scope of the present disclosure.

What is claimed is:

1. A switch device comprising:
an actuator;
a first cam configured to rotate when a front end portion or a rear end portion of the actuator is pressed down or pulled up, the first cam being engaged with an elongated hole extending in a front-rear direction of the actuator and formed in the actuator;
a second cam engaged with the actuator and configured to rotate due to movement of the actuator in the front-rear direction;
a plurality of plungers configured to be individually pressed down in response to rotation of the first cam or the second cam;
a plurality of movable contacts, each movable contact being configured to be pressed down by a corresponding one of the plurality of plungers; and
a plurality of fixed contacts, each fixed contact being provided opposed to a corresponding one of the plurality of movable contacts.

2. The switch device according to claim 1, wherein
the first cam is arranged at each of a position corresponding to a front portion of the actuator and a position corresponding to a rear portion of the actuator,
the second cam is arranged at a position corresponding to a central portion of the actuator in the front-rear direction.

3. The switch device according to claim 2, wherein
the actuator includes
an operation knob;
a base portion connected to a lower portion of the operation knob; and
a recess formed in a central portion of a lower portion of the base portion and configured to engage with the second cam,
the elongated hole that is engaged with the first cam arranged at each of the position corresponding to the front portion of the actuator and the position corresponding to the rear portion of the actuator is formed at each of one side in a width direction at a front end portion of the base portion, and another side in the width direction at a rear end portion of the base portion.

4. The switch device according to claim 3, wherein
the first cam arranged at the position corresponding to the front portion of the actuator includes
a first arm extending forward of the actuator and configured to engage with the elongated hole formed in the front end portion of the base; and
a second arm extending rearward of the actuator,
the first cam arranged at the position corresponding to the rear portion of the actuator includes
a third arm extending rearward of the actuator and configured to engage with the elongated hole formed in the rear end portion of the base; and
a fourth arm extending forward of the actuator,
the second cam includes
a fifth arm extending forward of the actuator;
a sixth arm extending rearward of the actuator; and
an engaging portion extending upward of the actuator and having a distal end engaged in the recess,
the plurality of plungers include a first plunger through a sixth plunger corresponding to the first arm through the sixth arm,
the plurality of movable contacts include a first movable contact through a sixth movable contact corresponding to the first plunger through the sixth plunger, and
the plurality of fixed contacts include a first fixed contact through a sixth fixed contact corresponding to the first movable contact through the sixth movable contact.

5. The switch device according to claim 1, further comprising:
a case configured to rotatably support the first cam and the second cam.

6. The switch device according to claim 5, wherein
the case includes a rocking support portion configured to support the actuator in a rockable manner by abutting against a lower portion of the actuator when the front end portion or the rear end portion of the actuator is pressed down.

7. The switch device according to claim 1, further comprising:
an elastic sheet provided with the plurality of movable contacts.

8. The switch device according to claim 1, further comprising:
a printed wiring board provided with the plurality of fixed contacts.
